(19) United States
(12) Patent Application Publication
(10) Pub. No.: US 2018/0137556 A1
(43) Pub. Date: May 17, 2018

(54) TECHNICAL IMPROVEMENTS FOR E-COMMERCE BETWEEN AGENTS

(71) Applicant: Robert Andrew FIELD, Philadelphia, PA (US)

(72) Inventor: Robert Andrew FIELD, Philadelphia, PA (US)

(21) Appl. No.: 15/352,309

(22) Filed: Nov. 15, 2016

(51) Int. Cl. G06Q 30/06; G06Q 20/10

(52) U.S. Cl. CPC G06Q 30/0633; G06Q 20/10

(57) ABSTRACT

A financial exchange system and method is disclosed. The system and method include a global purchase order including a version specification portion, at least one financial authority identifier, a transaction identifier, and a producer code. A merchant creates the global purchase order and communicates the global purchase order to prospective customers. The customer then receives the global purchase order and forwards it along to the customer's financial provider agent in order for the customer to obtain other purchase details, such as price, in order to execute a purchase transaction.

### TECHNICAL FIELD

The disclosed embodiments are generally directed to technical improvements for e-commerce between agents, and more specifically to a system and method for electronic commerce between anonymous agents backed by a network of cooperating independent financial service providers.

### BACKGROUND

Merchants and customers who wish to engage in cash less financial transactions have several alternatives today. In almost every situation, the customer creates some version of a “promissory note” agreement which is given to the merchant who receives payment at a later time. Bank checks and credit/debit card transactions are examples of two financial transactions that fit into this scenario.

A bank check is a document that authorizes a payment of money from a particular bank account. The person writing the check, the drawer, must have a relationship with the bank, which typically includes having money on deposit with the bank. The bank check contains all transaction details necessary for the recipient to present the bank check to the bank and request payment including the bank check detailing a monetary amount, date, and a payee on the bank check-along with bank account identification and owner authentication. Forms of bank checks have been in use over the ages; however, as bank check processing systems became highly automated during the 20th century, bank check usage has increased to the point where billions of bank checks are created annually. Each check documents a single, non-negotiable transaction for exchange.

Credit/debit card transactions are other examples of financial transactions that fall into the “promissory note” model of financial transfer. To create a credit/debit transaction, the customer provides personal identification in the form of an account number and other data that is used by the merchant to collect payment. Sophisticated point of sale systems are currently being developed which will attempt to protect the customer's personal information, such as the personal information being encrypted as it is passed to a merchant's point of sale system, for example; however, personal information must be given to the merchant so that payment can be received. As such, customers must have faith that their personal information will not get misused. After the customer has provided the personal information, the merchant presents the customer's personal information to a payment service and the payment service typically assumes that the transaction is legitimate unless there is information suggesting that the personal information has been compromised.

The basics of individual transactions have not changed substantially from the original transaction models in the early 20th century. These basics include the customer presenting personal identification information to a merchant who must then decide if the information is valid and then must assume the risk associated with transferring the customer's personal identification to a payment service in order to receive payment for the transaction. The customer must also be willing to accept that the merchant, as well as any transaction processing centers or other intermediaries, will take sufficient precaution to prevent identity theft, since the release of customer information to other third parties can result in the creation of fraudulent transactions when the perpetrator of fraud presents a fraudulent transaction to a bank or financial service and requests payment.

### SUMMARY

A financial exchange system and method is disclosed. The system and method include a global purchase order including a version specification portion, at least one financial authority identifier, a transaction identifier, and a producer code. A merchant creates the global purchase order and communicates the global purchase order to prospective customers. The customer receives the global purchase order and forwards it along to the customer's financial provider agent to obtain other purchase details, such as price, in order to execute a purchase transaction.

A financial exchange system and method for performing a transaction within the financial exchange system are disclosed. The system and method include a global purchase order including a version specification portion, at least one financial authority identifier, a transaction identifier, and a producer code. A merchant creates the global purchase order and communicates the global purchase order to prospective customers, with the global purchase order being configured to identify the merchant's financial service provider to obtain other purchase details to allow the prospective client to obtain purchase details from the customer's financial service provider agent in order to allow the consumer to initiate a purchase from the customer's financial service provider to the merchant's financial provider. Other purchase details may include price. The purchase may be for at least one good and/or at least one service.

The version specification portion may include structured text. The structured text may allow at least one of the consumers, merchant and financial authority to interpret the remainder of the global purchase order.

The at least one financial authority identifier may include an identification sequence. The identification sequence uniquely may identify the financial authority.

The transaction identifier may be a unique identifier to reference the global purchase order. The transaction identifier may be assigned by the financial authority.

The producer code may be generated by the merchant. The producer code may provide security to the transaction.

### BRIEF DESCRIPTION OF THE DRAWINGS

A more detailed understanding may be had from the following description, given by way of example in conjunction with the accompanying drawings wherein:

FIG. 1 is a system diagram of a representative e-commerce system for transacting according to the present invention;

FIG. 1A is a system diagram of a representative e-commerce system for transacting according to the present invention where the consumer and merchant use different financial authorities;

FIG. 2 illustrates the global purchase order for use in the system of FIG. 1;

FIG. 3 illustrates a method for a purchase between merchant and consumer, as governed by financial authority; and

FIG. 4 illustrates a method for the global purchase order in transacting a purchase between merchant, consumer, and financial authority.

### DETAILED DESCRIPTION

A system and method is provided for executing financial transactions in a market where merchants and consumers may wish to perform electronic commerce without sharing any personal identification information between the merchant and the consumer. The merchants and the consumers independently employ a financial service provider to which they have a business relationship over a secured network connection. The financial service providers facilitate commerce on behalf of their clients, which may be merchants for one transaction and consumers for another transaction. Merchant and consumers use agents to communicate with their financial service provider over a network connection. No personal identification information is required between the merchant agent and the consumer agent. Instead, the merchant agent and merchant's financial service provider establish a global purchase offer. The merchant agent then creates a reference to the global purchase offer that can be communicated to the consumer agent. The consumer agent passes this reference along to the consumer's financial service provider. Financial service providers negotiate purchase offer information and execute transactions as directed by the consumer agent.

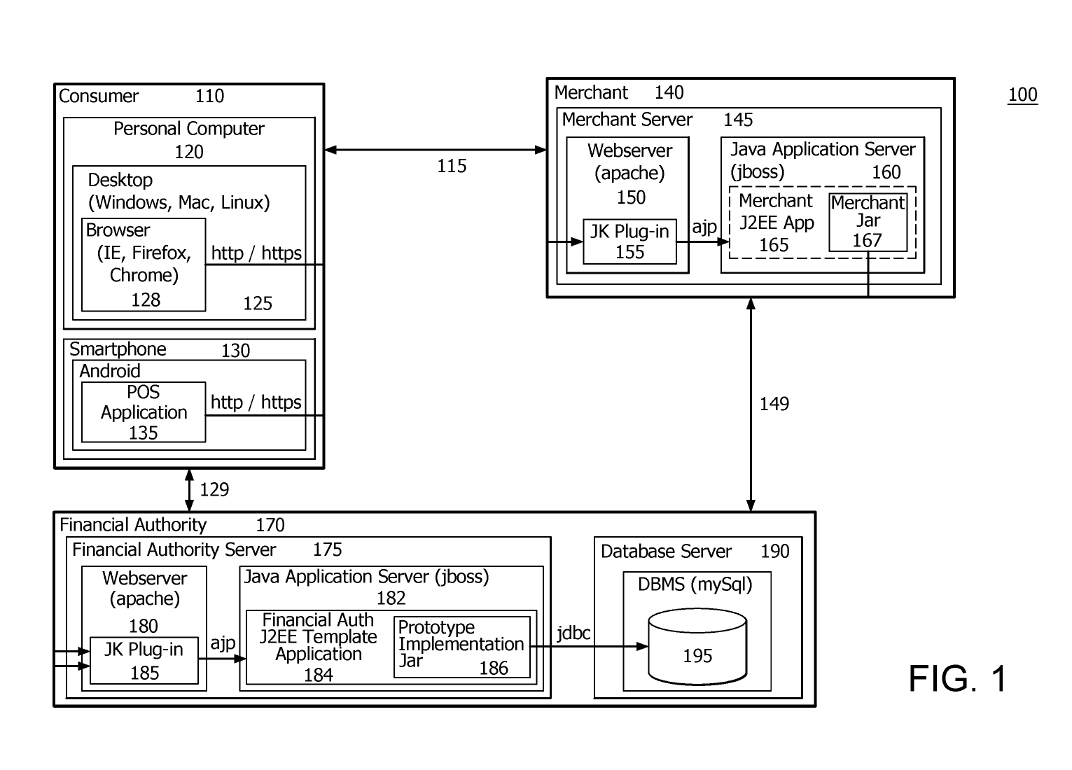

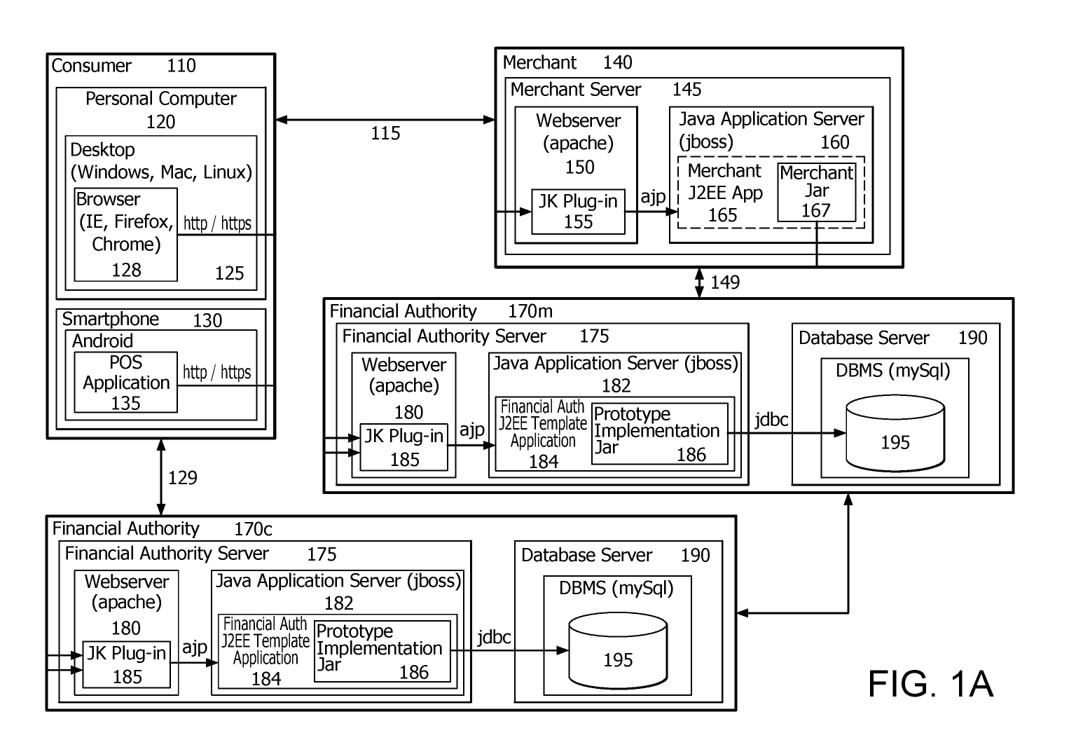

FIG. 1 illustrates a representative e-commerce system 100 for transacting according to the present invention. E-commerce system 100, in its most basic form, includes a consumer 110, a merchant 140 and a financial authority 170. Consumer 110 may represent the buyer of a good or service provided or sold within e-commerce system 100. Merchant 140 may represent the seller of a good or service provided or sold within e-commerce system 100.

Consumer 110 may access the e-commerce system 100 via a personal computer 120 or smartphone 130. The personal computer 120 may be a desktop personal computer 125 based in windows, mac, or Linux operating system. Desktop 125 may include a browser 128 that allows access to sites as will be described below. Browser 128 may be a Firefox, IE or Chrome browser, for example.

Smartphone 130 operates using any operating system, including, but not limited to, android, iOS, Blackberry 10, for example. Smartphone 130 may include a point-of-sale application 135 or other application enabling connection with system 100. Consumer 110 may want rapid, safe purchasing experiences and in today's day and age are willing to use smartphone 130, computer 120 or another point of sale device for purchase (not shown).

Merchant 140 may access the e-commerce system 100 via an e-commerce server (not shown), a personal computer (not shown) or smartphone (not shown). By way of example, if merchant 140 sells goods/services on the Internet, the merchant's 140 e-commerce server is configured to access the financial authority 170. The e-commerce server may be a dedicated hosting service that has been configured to include the capability to communicate securely with the merchant's financial authority. The personal computer may be a desktop personal computer based in windows, mac, or Linux operating system. Desktop may include a browser that allows access to sites as will be described below. Browser may be a Firefox, IE or Chrome browser, for example. Merchant 140 may utilize a merchant server 145 to provide access to a multitude of consumers 110.

Merchant server 145 may include a webserver 150. Web server 150 may be a computer or series of computers that deliver web pages. Web server 150 has an IP address, or even multiple such addresses, and possibly a domain name. The server then fetches static HTML pages (example, content files, such as index.html) and sends them to the consumer 110's browser. Web server 150 may contain software enabling it to act as a server, such as server software, and connecting the machine to the Internet. Commercial products, such as the Open Source Apache product, may be employed to implement this web server functionality. Apache is the name of a commercially available open source webserver implementation. Apache is well suited for delivering static content and has a sophisticated framework for including plug-ins to generate dynamic content. There are many web server software applications, including public domain software and commercial packages. Merchant server 145 may also include other commercial products, such as a JK plug-in 155 product, to route dynamic HTTP requests to a Java application server 160.

The JK plug-in 155 may be an open source software product that works with Apache. The product acts as a bridge or proxy between an Apache web server, which interacts with desktops on the Internet using the HTTP protocol to serve HTML pages [content] and an application server 160. Examples of application server 160 products include IBM's WebSphere product, Red Hat's Jboss product, and Oracle's Open Source Tomcat server. Application server 160 may implement business logic, such as the implementation of an Internet shopping market, for example, using the Java Programming Language. Separating business logic on application server 160 from other aspects of web server functions including Apache may result in higher security and greater scalability than can be found in other system architectures.

Merchant server 145 may also include a Java application server 160. Java application server 160 may include an application server to interact in Java, or any other language. Java is a high-level programming language that is a commonly used foundation for developing and delivering content on the web. Server 160 may provide network resources that are delivered in the web. Merchant server 165 may include a custom developed merchant J2EE application 165 which may also use a merchant Jar 167 to communicate with a financial authority 170 service provider.

For software developers who develop software using the Java programming language, Java 2 Enterprise Edition (J2EE) is a qualifier to reflect a commonly accepted set of available library services for developing Internet applications including security and session management, web container services, and other enterprise services, for example. The merchant J2EE application 165 may include software that merchant 140 develops to host an e-commerce website that interacts with the financial authority 170. Merchants 140 that provide goods and services on the Internet often use a “shopping cart” paradigm to model a shopping experience on their website. The merchant 140 communicate with the financial authority 170 for the purpose of creating global purchase orders, and for learning if/when any purchases have been executed and/or accepted. According to an implementation, the merchant Jar 167 is software that is provided by the financial authority 170 in order to minimize the amount of software developed by merchant 140. Initial merchant libraries may be developed to run on under both Windows and Linux Operating Systems programmed with Java, Perl, or the PHP programming languages.

The merchant 140 generally desires to increase sales and to realize or monetize the purchase revenue.

Financial authority 170 may access the e-commerce system 100 via a personal computer (not shown) or smartphone (not shown). The personal computer may be a desktop personal computer based in windows, mac, or Linux operating system. Desktop may include a browser that allows access to sites as will be described below. Browser may be a Firefox, IE or Chrome browser, for example. Financial authority 170 may utilize a financial authority server 175 to provide access to a multitude of consumers 110 and merchants 140.

Financial authority 170 may include a webserver 180. Web server 180 may be a computer or series of computers that deliver web pages. Web server 180 has an IP address, or even multiple such addresses, and possibly a domain name. The server then fetches HTML pages (example, static content files, such as index.html) and sends them to the requestor's browser. Web server 180 may contain software enabling it to act as a server, such as server software, and connecting the machine to the Internet. Commercial products, such as the Open Source Apache product, may be employed to implement this web server functionality. There are many web server software applications, including public domain software and commercial packages. Financial authority 170 may also include a JK plug-in 185 product to route dynamic HTTP requests to a Java application server 182.

Financial authority 170 may also include a Java application server 182, which may be implemented by a commercial product, such as Jboss application server or IBM WebSphere. Jboss is the name of an application server product for hosting J2EE applications. Other examples of Java Application Servers include IBM's WebSphere product, BEA's WebLogic product, and Oracle's Open Source Tomcat product.

Java application server 182 may include an application server to interact in Java, or any other language. Java is a high-level programming language that is a commonly used foundation for developing and delivering content on the web. Server 182 may provide network resources that are delivered in the web.

The Java application server 182 may contain software to implement business logic for the financial application services. These services may be designed to incorporate a financial authority application template, such as the J2EE template application 184 to enable the development of alternative, compatible financial application implementations, as well as an implementation Jar 186, which completes the implementation of all services defined by the template. Financial authority 170 may include a database server 190 and a DBMS (mySql) 195.

As shown in FIG. 1, the financial authority 170 for both the merchant 140 and consumer 110 may be the same. As would be realized by those with a pertinent skill in the art, multiple financial authorities 170 may be utilized. In such an implementation, shown in FIG. 1A, merchant 140 may have one financial authority 170m and consumer 110 may have a second financial authority 170c. In such a configuration, merchant financial authority 170m and consumer financial authority 170c may be in communication with each other in order to enable the transaction to occur as will be discussed herein below. When system 100 is designed to include multiple financial authorities 170, financial authorities 170 may have established relationships, such as authority accounts, for example, with others of financial authority 170. If a consumer 110 initiates a purchase from merchant 140 that is using a different financial authority 170m from the consumer's financial authority 170c, financial authority 170c may use its authority account to initiate a purchase by proxy from financial authority 170m using the same communication protocols and interfaces as if the consumer 110 and merchant 140 shared the same financial authority 170. Once the purchase transaction is complete, both the consumer financial authority 170c and merchant financial authority 170m may contain sufficient transaction details to confirm that the purchase was completed successfully. It is even conceived that multiple financial authorities may be used for the merchant financial authority 170m and/or the consumer financial authority 170c. Financial authority 170 seeks low cost per transaction financial services.

For transactions where consumer 110 and merchant 140 use different financial authorities 170, financial authority 170c may broker the transaction for consumer 110 while using the same communication process with financial authority 170m as if consumer 110 and merchant 140 existed within the same financial authority 170m.

As a result of the multiple financial authorities 170, financial authority 170c may have additional requirements as described below. Since a global purchase order contains the identification of financial authority 170m, whenever financial authority 170c receives a request to get details for a global purchase offer from merchant 140 that uses another financial authority 170, financial authority 170c creates a request for the purchase offer details from financial authority 170m. In order for financial authority 170c to create such a request, consumer's 110 financial authority 140 needs to have a relationship with the financial authority 170m. Such a relationship may take the form of an authority account.

In an implementation where financial authority 170c fails to recognize or have the ability to communicate with financial authority 170m, financial authority 170c returns an error to indicate that financial authority 170m is not accessible to consumer 110.

In an implementation where financial authority 170c recognizes and/or communicates with financial authority 170m, financial authority 170c requests purchase order details from merchant's financial authority 170m, such as by proxy, for example. The resulting purchase details obtained by financial authority 170c may be returned to consumer 110.

Purchase requests between financial authorities 170 initiated by consumer 110 to the financial authority 170c may be implemented as follows.

Financial authority 170c requests purchase order details from financial authority 170m. Since the purchase information contains price information, financial authority 170c may consider the price in the price information as a not to exceed price as described below.

Financial authority 170c checks to ensure that consumer 110 has sufficient funds, including forms of funds such as credit lines and available account balances, to make the required purchase from financial authority 170m. If there are insufficient funds available, an appropriate message is returned to consumer 110 and the transaction is canceled. If there are sufficient funds available to consumer 110, financial authority 170c may debit consumer's 110 account.

Financial authority 170c initiates a purchase such as by proxy using the not to exceed a designated price to financial authority 170m. Since financial authority 170c has a relationship with the merchant's financial authority as determined above, financial authority 170m completes the purchase transaction within financial authority 170m and returns a purchase confirmation to financial authority 170c. Once the purchase confirmation is returned to financial authority 170c, financial authority 170c communicates to consumer 110 that the purchase has been completed. Both consumer 110 and merchant 140 have transaction details available to confirm that the purchase was completed successfully.

Financial authority 170c and financial authority 170m may utilize their business relationship to time the actual exchange of funds from one to the other. For example, the transfer need not happen in real time, although it certainly can. Other interfaces, such as a banking ACH transactions through third party banking providers, may be used to transfer funds between financial authorities 170, merchant 140 and consumer 110.

Communication between the consumer 110 and the merchant 140 is depicted as occurring across communication path 115. Communication path 115 represents a communication path between the consumer 110 and merchant 140. This path 115 may be wired or wireless and also may be an in-person communication, such as face-to-face, for example. Over this communication path 115, consumer 110 may select which products consumer 110 is interested as provided by merchant 140. Consumer 110 may elect to make a purchase of a product, for example. Consumer 110 may provide shipping or logistical information.

Merchant 140 may provide consumer 110 with details of the product, cost of the product and other information necessary for consumer 110 to make a decision about the purchase of the product. Other communications on path 115 may include the Internet, if merchant 140 offers products and services through e-commerce communications between the merchant 140 and consumer 110.

Communication path 149 joins merchant 140 with financial authority 170. This path 149 may be wired or wireless and also may be an in-person communication, such as face-to-face, for example. Over this communication path 149, merchant 140 may request the creation of the global purchase order from financial authority 170. Merchant 140 may send transaction details to financial authority 170 across path 149. Transition details may include a purchase price, a time duration for which the global purchase offer is to be considered “valid”, and other transaction qualifications, such as if a shipping address is required, or if gratuity is being solicited, for example. Financial authority 170 may respond to merchant 140 with a global purchase order for the transaction. Merchant may render the global purchase offer as a barcode or other identifier to include in a purchase summary page.

Communication path 129 joins consumer 110 with financial authority 170. This path 129 may be wired or wireless and also may be an in-person communication, such as face-to-face, for example. Over this communication path 129, consumer 110 may request financial details from the financial authority 170 using the global purchase order previously received from the merchant 140. Consumer 110 may then elect to accept purchase terms and may then, using path 129 with the financial authority 170, instruct the financial authority 170 to execute the purchase the transaction designated in the global purchase order. Financial authority 170 may send a purchase complete response to consumer 110. Other communications on path 129 may include standard banking requests, such as requests to obtain account balances, review account and purchase history, and to request, receive, and respond to financial services, such as loans, insurance, or investment opportunities, for example.

The financial authority 170 provides applications 135 to consumers 110 such that consumers 110 may use applications 135 on smartphone 130. The financial authority 170 provides merchant 140 an account. The application 135 and account enables transaction between consumer 110 and merchant 140.

The global purchase order, coupled with systems and methods capable of processing global purchase orders may provide the ability to eliminate or minimize the risks of fraud that are inherent to all forms of promissory note type transactions. In the present system and method there is no personal information with respect to either the consumer 110 or the merchant 140 within a global purchase order. The purpose of a global purchase order is simply to advertise the existence of an offer that exists within a designated financial authority 170. Details of the offer, such as price or a description of the offer, are specifically not included within the global purchase order. In order to use a global purchase order, merchants 140 and consumers 110 may maintain a relationship with a financial authority 170 who will then transact business on their behalf.

Financial transactions with a global purchase order may be brokered by financial authority 170; however, merchants 140 and consumers 110 do not need to subscribe to the same financial authority 170. Financial authority 170 service providers are all well-known within the community in which they operate. Transactions are exchanged between financial service 170 providers in a well-defined, secure operating environment.

Fraud is eliminated or minimized in a global purchase order based transaction because no private data is exchanged between the merchant 140 and consumer 110. More importantly, the actual purchase transactions are brokered through financial authority 170, as opposed to the generally accepted merchant 140 and the merchant's bank concept in use today. To initiate a transaction, a merchant 140 interacts with his financial authority 170 to create a global purchase order.

During this global purchase order creation process, additional information, such as purchase price, duration of offer, and other purchase details, may be sent to the merchant's financial authority 170 so that the financial authority 170 is able to accept purchase transactions on behalf of the merchant 140. Once a global purchase order has been created, it is given to the merchant 140.

A merchant 140 may decide to share this global purchase order with a single consumer 110 or, if the merchant 140 is offering a product or service to a community of potential consumers 110, the global purchase order may be shared with the general public. In the one-to-many configuration, the global purchase order may operate conceptually as a Universal Product Code; however, the global purchase order references a potential financial transaction that exists within a specific financial authority 170 and the Universal Product Code is simply an identification number for a consumer product.

Consumers 110 may rely on their own financial authority 170 to obtain purchase details prior to committing to a purchase. Consumers 110 receive a global purchase order from merchant 140, but details about the potential purchase are received from the financial authority 170c. If the consumer 110 and merchant 140 share the same financial authority 170, the financial authority 170 can easily share information about the merchant's 140 global purchase offer. If the consumer 110 and merchant 140 do not share financial authorities 170, the financial authority 170c must first obtain the merchant's 140 purchase details from the financial authority 170m before it can be shared with the customer. These transactions may take place in real time, as long as the financial authorities 170 are available on the network.

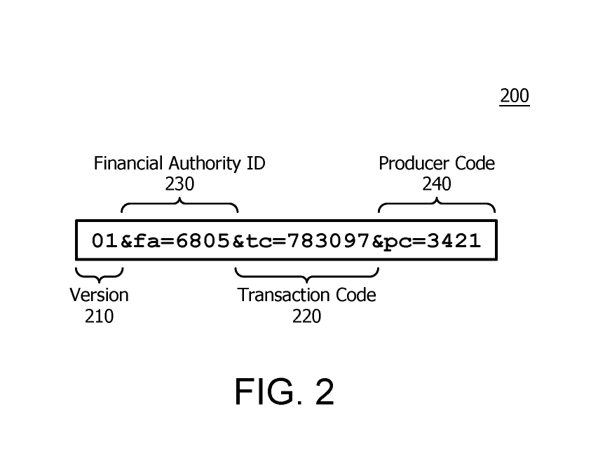

FIG. 2 illustrates the contents of the global purchase order 200 for use in system 100. The global purchase order 200 includes version information 210, transaction code 220, financial authority identification 230 and a producer code 240. The components of the global purchase order 200 may be encoded using a large number of industry standard technologies, including Extensible Markup Language (XML), JavaScript Object Notation (JSON), delimited or fixed formatted ASCII, Unigorm Resource Locator (URL), and barcode (such as the QR code or CODE39).

The version information 210 may include structured text designed to identify the global purchase order 200 and enable compatibility. Applications, such as consumer applications, merchant applications and financial authority applications, can read the version information 210 and use this information 210 to interpret the remainder of the data within the global purchase order 200.

As shown in FIG. 2, the version information 210 may be “01.” Other values for the version code are reserved for future use.

A transaction code 220 is a unique identifier that is created by the financial authority 170 to reference a specific global purchase order 200. Transaction code 220 may include details about global purchase order 200, including price and offer expiration date of transaction. Information about the transaction may be obtained from financial authority 170 using the transaction code 220 and producer code 240 (discussed herein below).

As shown in FIG. 2, transaction code 220 may be tc=783097, by way of example only. The transaction code 220 is an identifier, created by a specific financial authority 170, which is used to reference a unique transaction within the specific financial authority 170. The financial authority 170 may use an implementation specific algorithm (such as generating a unique timestamp or using a simple “one up counter” to create a unique transaction code 220). The “tc” represents transaction code 220. The value “783097” should be interpreted as the unique transaction code 220 within the example global purchase order. By way of example, the value “783097” may represent the 783,097th global purchase order created within the financial authority since the beginning of a particular timeframe. Transaction code 220 may be unique to a specific financial authority.

The financial authority identification 230 includes an identification sequence that uniquely identifies the financial authority 170 within a network of financial authorities. This network of financial authorities may be trusted authorities and may include authorities not identified as trusted. The financial authority identification 230 may be similar to a bank routing number in the banking industry. The set of valid financial authority identifications 230 may be shared and known among financial authorities 170.

As shown in FIG. 2, financial authority identifier 230 may be fa=6805. The “fa” represents financial authority identifier 230. The value “6805” may be interpreted as the financial authority identifier 230 within the example global purchase order. While the financial authority identifier 230 in this example depicts a system defined numeric value, the financial authority identifier 230 may also include alphanumeric characters, such as fa=fieldsystem.homedns.org, for example. Financial authority identifier 230 may include a reference to a single financial authority 170, for example. Operationally, this may be similar to a bank check including a bank routing number that is used by the merchant's bank during the settlement process.

The producer code 240 is data that is created by merchant 140. Merchant 140 may generate a random producer code 240 token to provide security to a transaction within system 100 in order to prevent third party services that may be attempting to build an inventory of active transactions from obtaining or having access to the information. Merchant 140 may utilize producer code 240 to contain advertising identification or a discount code. Advertising information may enable the merchant 140 to receive feedback to determine which global purchase orders 200 have been successful. A discount code may enable the merchant 140 to provide goods and services to preferred customers at discounted rates.

As shown in FIG. 2, producer code 240 may be pc=3421. The “pc” represents the producer code 240. The value “3421” is the producer code 240 within the example global purchase order

The structured text used to identify a global purchase offer contains alphanumeric fields that are separated by a separator character. Separator character may be an ampersand or other character. The use of an ampersand as a separator character enables global purchase orders to be encoded as legitimate URLs, such as the following:

http://fieldsystem.homedns.org:8080/Authority/Service?vc=01&fa=6805&tc=7 83097&pc=3421

In this implementation using ampersand as a field delimiter, the first field of the global purchase order is:

http://fieldsystem.homedns.org:8080/Authority/Service?vc=01

which can be used to provide an Internet address to financial authority 170. When the global purchase order is encoded as a QR code and passed between smart phone applications that interact with financial authority 170, this first field may be ignored. Consumers 110 lacking a relationship with financial authority 170 may utilize their smartphone to read and follow the link that is encoded within the QR encoding of a global purchase order. In such an implementation, the link sends consumer 110 to a web page where the purchase transaction can be completed using another payment method.

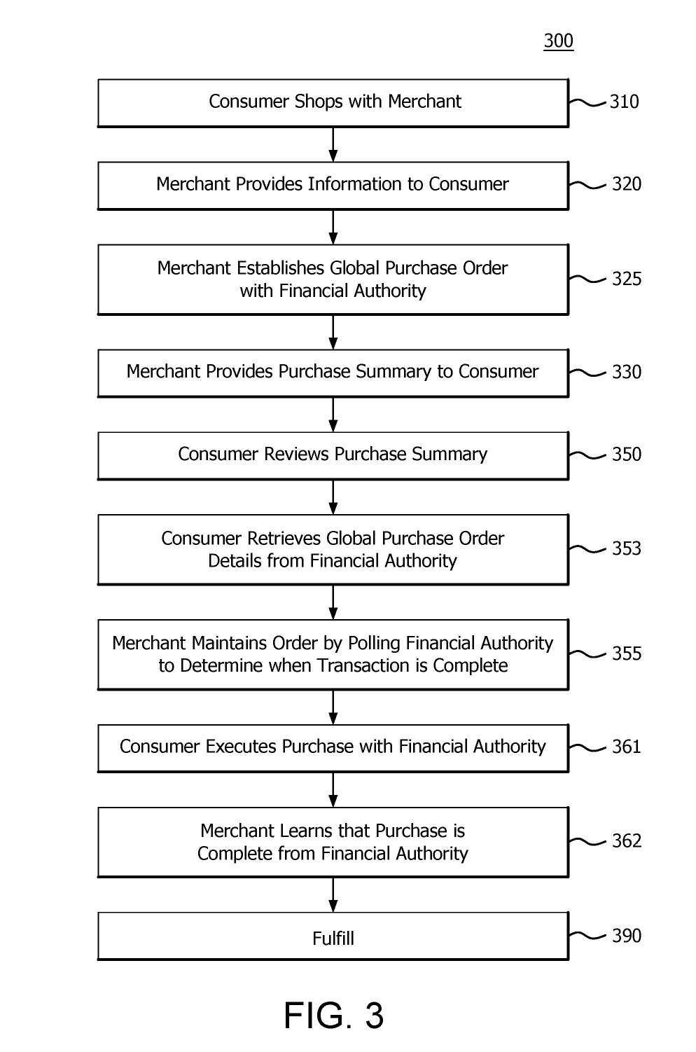

FIG. 3 illustrates a method 300 for a purchase between merchant 140 and consumer 110, as governed by financial authority 170. Method 300 may be initiated when a consumer 110 shops with merchant 140 at step 310. This shopping may occur either directly within a brick and mortar store, or online via an online website or dedicated application, for example, where the website or application is activated or operated within personal computer 120 and/or smartphone 130. Merchant 140 may provide information to consumer 110 at step 320. This information may include specific information about the product or service which the consumer 110 is shopping for and/or may include information regarding the list price and standard delivery options or date for the product or service. For example, a merchant 140 may provide the type, SKU#, list price and standard delivery terms for a particular set of electronics that the consumer 110 is shopping for. This may include, for example the resolution of a television, the maker of the television and speakers, the SKU# information, a list price for the system and delivery terms on which the system can be delivered and assembled. In providing information to consumer 110 at step 320, the merchant 140 may wish to establish a global purchase order 200 in order to allow the consumer 110 to execute the purchase. The merchant 140 may then contact the financial authority 170 and request the creation of a global purchase order 200 at step 325. Purchase price details are included in the merchant's 140 request to the financial authority 170 to create a global purchase order 200. Once the merchant 140 receives a global purchase order 200 from the financial authority 170, the merchant 140 may also create a purchase summary at step 330 that may be provided to the consumer 110 at step 330. The consumer 110 may review the purchase summary at step 350. After reviewing the purchase summary at step 350, consumer 110 may retrieve global purchase order 200 details from financial authority 170 at step 353.

Merchant 140 may maintain an open order associated with the purchase summary and may poll the financial authority 170 to determine if a transaction is complete at step 355. Step 355 may occur at any point within method 300 from the time the merchant 140 creates the purchase summary at step 325 until the consumer 110 executes the purchase with the financial authority 170 in step 361 below.

A consumer 110 may initiate a purchase with the financial authority 170 starting at step 350. The initiation of a purchase may be based on the purchase summary created and provided to the consumer 110 at step 330. The consumer 110 may elect to forward the global purchase order provided within the purchase summary in step 350 to the financial authority 170 at step 353 in order to obtain purchase details from the financial authority 170. If the consumer 110 accepts the purchase terms provided by the financial authority 170 in step 353, the consumer 110 may then complete the transaction by executing a purchase with the financial authority 170 at step 361. Once the transaction is completed with the financial authority 170, the merchant 140 is alerted to the completed purchase as a result of polling the financial authority 170 in step 355. Once the consumer 110 and merchant 140 have received confirmation from the financial authority 170 that a purchase has been completed for the global purchase order 200 at step 362, the terms of the purchase may be fulfilled by the merchant 140 at step 390. Since the confirmation for purchase comes from financial authority 170, as opposed to client 110 or merchant 140, the purchase cannot be alleged to be complete by any party in the transaction until the transaction is complete from the financial authority 170 perspective.

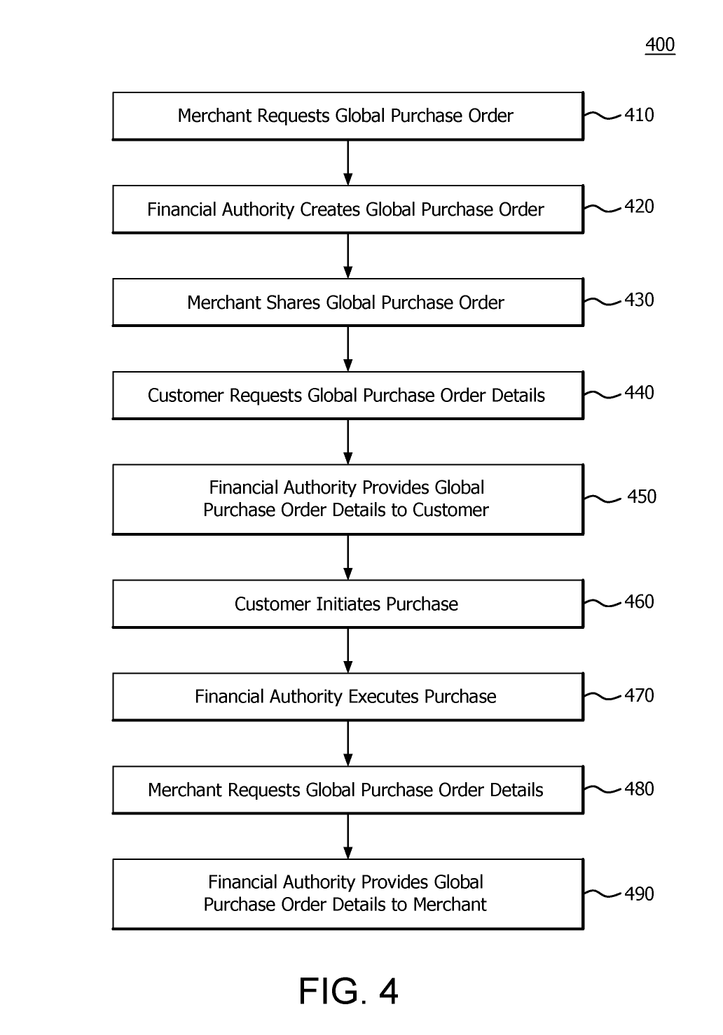

FIG. 4 illustrates a method 400 for the global purchase order 200 in transacting a purchase between merchant 140, consumer 110, and financial authority 170. The purchase is initiated, for the sake of discussion and illustration in method 400, when merchant 140 and consumer 110 are engaged at the point of purchase of goods or services. The merchant 140 communicates information to describe the financial aspects of the transaction, including purchase price, duration of offer, and other pertinent details, to the financial authority 170 in requesting the global purchase order 200 for the transaction at step 410. Upon receiving this request, financial authority 170 creates the global purchase order 200 for the transaction at step 420 and the global purchase order 200 is provided to the merchant 140. The merchant 140 shares the global purchase order 200 with consumer 110 at step 430. The consumer 110 sends the global purchase order 200 to the financial authority 170 requesting global purchase order 200 details for the transaction at step 440. The financial authority 170 uses the global purchase order 200 to find details about the desired transaction, including, but not limited to, purchase price, duration of offer, and other transaction details, and returns this information to the consumer 110 at step 450. The consumer 110 reviews the information returned from the financial authority 170, and if the customer maintains a desire to purchase the good or service involved in the transaction, the consumer 110 then requests the financial authority 170 to initiate a purchase at step 460. The financial authority 170 determines if the consumer 110 has sufficient funds, or credit, for the transaction and if so executes the purchase at step 470. The merchant 140 periodically requests the global purchase order 200 details from the financial authority 170 at step 480. These requests for purchase details may occur at a rate of one request every few seconds until either the global purchase order 200 expires or the consumer executes a purchase. The financial authority 170 provides the global purchase order 200 details to the merchant 140 at step 490, and if the purchase order status indicates that the global purchase order 200 has been purchased, the merchant 140 fulfills the purchase with the consumer 110 by providing goods or services. Since the confirmation for purchase comes from financial authority 170, as opposed to client 110 or merchant 140, the purchase cannot be alleged to be complete by any party in the transaction until the transaction is complete from the financial authority 170 perspective.

Within a financial authority system, there exists extensive communication between merchant 140 and financial authority 170, between consumer 110 and financial authority 170 and between financial authorities (when the merchant 140 and consumer 110 do not share a common financial authority 170). Communication among these parties is necessary to create global purchase orders, exchange global purchase order information and to authorize the purchase of global purchase order transactions. This communication may integrate a number of industry standard network communication protocols, such as HTTP and HTTPS as well as implementation specific protocols that build on TCP/IP and UDP/IP. Information may be also be exchanged between the merchant 140 and consumer 110 using industry standard barcodes (such as the QR code and CODE39) or Near-Field Communication (NFC) protocols.

The following sections describe examples of communication between agents within a financial authority system (although the examples use XML to describe the information that is contained within each exchange, other industry standard technologies could be used to encode the same information):

The Create Global Purchase Order Request is created by the merchant 140 to advertise a good or service that is available for purchase. It may be used in real time (within a point of sale application) or it may be used in advance of a purchase (for example, to create purchasable items within an advertising instrument).

In the example below, a merchant 140 is offering entry into the Tower of London as a service to a traveler wishing entrance to the Tower of London sends a CreateOffer service request to the financial authority 170 requesting the creation of a global purchase order 200 with the following additional purchase information: the entrance fee will be £10, the offer will be valid for 5 minutes, the memo line for the transaction will read “Entrance fee to the Tower of London”, and the producer code for this transaction will be “43661”:

<request>
<requestId>3</requestId>
<service>CreateOffer</service>
<authorization>
<id>ubm</id>
<password>moose</password>
<accountId>54321</accountId>
</authorization>
<offer>
<accountId>54321</accountId>
<askingPrice>GBP 10</askingPrice>
<duration>5m</duration>
<memo>Entrance fee to the Tower of London</memo>
<token>43661</token>
</offer>
</request>

In the request above, the requestId indicates that this is the third request passed to the financial authority since this network communication channel was established. The authorization information is used to identify the merchant 140 to the financial authority. If the CreateOffer request received by the financial authority 170 is in good order, the financial authority 170 may respond to the merchant 140 with information similar to below:

<response>
<requestId>3</requestId>
<status>1</status>
<offer>
<authorityId>20</authorityId>
<transactionCode>282</transactionCode>
<token>43661</token>
</offer>
</response>

In the response above, the requestId indicates that this response is with regard to the 3rd request that was passed to the financial authority since the network communication was established. The status value of “1” in this example indicates that no errors or exceptions were encountered and details of the global purchase offer 200 are described within the offer element.

A merchant 140 needs to communicate the global purchase offer 200 to the consumer 110. Several technologies, such as barcodes or Near-Field Communication (NFC) protocols can be used to facilitate this communication. The QR barcode is one possible implementation for sharing a global purchase offer 200 between a merchant 140 and a consumer 110. In this example, the barcode could be rendered on the display of a point of sale application located at the entrance of the Tower of London. If the consumer 110 wishes to enter the Tower of London, the consumer 110 can use a smartphone to load the barcode into their financial authority smartphone application and communicate with their own financial authority 170 to determine if they wish to purchase entry into the Tower.

Once a consumer 110 has obtained information about a global purchase order 200, they can initiate a request for purchase order details from their own financial authority 170 (note that the consumer 110 and merchant 140 need not share the same financial authority 170).

The example below shows one implementation for how a consumer 110 requesting global purchase order details from a financial authority 170. In this example, the requestId indicates that this is the second request on this network communication channel between the consumer 110 and the financial authority 170. The authorization information is used to identify the consumer 110 to their financial authority 170. The Service requested, “getOffer”, indicates that the consumer 110 would like the financial authority to obtain details for the specified global purchase order 200 and return the purchase details within the response. Note that the global purchase order information (financial authority identification 230, transaction code 220, and a producer code 240 which is encoded into the token element)

<request>
<requestId>2</requestId>
<service>getOffer</service>
<authorization>
<id>urjs</id>
<password>squirrel</password>
<accountId>12345</accountId>
</authorization>
<offer>
<authorityId>20</authorityId>
<transactionCode>282</transactionCode>
<token>43661</token>
</offer>
</request>

Once the financial authority 170 receives this request, assuming everything is in order and that there are no errors or exceptions, the financial authority 170 may respond with a response similar to the one listed below:

<response>
<requestId>2</requestId>
<status>1</status>
<offer>
<authorityId>20</authorityId>
<transactionCode>282</transactionCode>
<askingPrice>GBP 10</askingPrice>
<memo>Entrance fee to the Tower of London</memo>
<token>43661</token>
<dbaName>City of London</dbaName>
</offer>
</response>

In this response, the requestId with a value of 2 indicates that the financial authority 170 is responding to the 2nd request that was passed to the financial authority since the network communication was established. The status of 1 indicates that there were no errors or exceptions and the offer details are returned within the offer element of the request.

The consumer 110 reviews the details of the global purchase offer 200 and decides to either ignore the global purchase order or the consumer 110 may elect to initiate a purchase request. The example below shows information that a consumer 110 may send to their financial authority 170 if the consumer 110 wishes to initiate the purchase of a global purchase order 200:

<request>
<requestId>3</requestId>
<service>Purchase</service>
<authorization>
<id>urjs</id>
<password>squirrel</password>
<accountId>12345</accountId>
</authorization>
<offer>
<authorityId>20</authorityId>
<accountId>12345</accountId>
<transactionCode>282</transactionCode>
<token>43661</token>
</offer>
</request>

In this example request, requestId of 3 indicates that this is the third request that has been passed from the consumer 110 to the financial authority 170. The service value of “Purchase” indicates that consumer is instructing the financial authority to perform a purchase of the global purchase offer 200 that is described in the offer section of the request. At this point, the financial authority 170 can complete a purchase transaction if the consumer 110 and merchant 140 use the same financial authority 170. If the consumer 110 and merchant 140 do not use the same financial authority 170, a financial authority implementation may complete the purchase by executing the following sequence of steps: execute a partial purchase transaction from the consumer 110 to ensure that funds are available and debited from the consumer's 110 account; execute a purchase by proxy with the merchant's 140 financial authority 170; and complete the partial purchase transaction with the consumer 110. Assuming that everything is in order and that there are no errors or exceptions raised within the financial authority 170, the financial authority may respond to the consumer's 110 purchase request with the following purchase response:

<response>
<requestId>3</requestId>
<status>1</status>
</response>

In this response, requestId with a value of 3 indicates that this is the 3rd response from the financial authority 170 to the consumer 110 since this network communication path was established.

As a result of receiving this response, the consumer 110 is informed that they have purchased the global purchase order as requested. A transaction history of the purchase may be maintained within the financial authority 170 to remediate claims from either the consumer 110 or the merchant 140.

In order for the merchant 140 to receive notification that a global purchase offer 200 purchase has been executed, the merchant 140 may elect to poll the financial authority 170 (using a request similar to the get purchase offer 200 details described above). Since the merchant 140 is requesting details about a global purchase offer 200 that the merchant 140 created, an implementation may send additional information, such as details describing the purchase history for the global purchase offer 200. An implementation may collect transaction history within the financial authority 170 to remediate claims from either the consumer 110 or the merchant 140.

Although features and elements are described above in particular combinations, one of ordinary skill in the art will appreciate that each feature or element can be used alone or in any combination with the other features and elements. In addition, the methods described herein may be implemented in any order in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A financial exchange system, said system comprising
a global purchase order including a version specification portion, at least one financial authority identifier, a transaction identifier, and a producer code,
wherein a merchant creates the global purchase order and communicates the global purchase order to prospective customers, with the global purchase order being configured to identify the merchant's financial service provider to obtain other purchase details to allow the prospective client to obtain purchase details from the customer's financial service provider agent in order to allow the consumer to initiate a purchase from the customer's financial service provider to the merchant's financial provider.

2. The system of claim 1, wherein other purchase details comprise price.

3. The system of claim 1, wherein the purchase is for at least one good.

4. The system of claim 1, wherein the purchase is for at least one service.

5. The system of claim 1, wherein the version specification portion comprises structured text.

6. The system of claim 5, wherein the structured text allows at least one of the consumers, merchant and financial authority to interpret the remainder of the global purchase order.

7. The system of claim 1, wherein the at least one financial authority identifier comprises an identification sequence.

8. The system of claim 7, wherein the identification sequence uniquely identifies the financial authority.

9. The system of claim 1, wherein the transaction identifier is a unique identifier to reference the global purchase order.

10. The system of claim 1, wherein the transaction identifier is assigned by the financial authority.

11. The system of claim 1, wherein the producer code is generated by the merchant.

12. The system of claim 1, wherein the producer code provides security to the transaction.

13. A method for conducting a purchase in a financial exchange, the method comprising:
requesting a global purchase order;
creating a global purchase order, the global purchase order including a version specification portion, at least one financial authority identifier, a transaction identifier, and a producer code;
sharing the global purchase order with prospective customers;
retrieving global purchase order details from the at least one financial authority;
executing the purchase with the financial authority;
upon learning that purchase is complete, fulfilling the purchase order.

14. The method of claim 13, wherein the purchase is for at least one good or at least one service.

15. The method of claim 13, wherein the version specification portion comprises structured text that allows at least one of the consumers, merchant and financial authority to interpret the remainder of the global purchase order.

16. The method of claim 13, wherein the at least one financial authority identifier comprises an identification sequence.

17. The method of claim 16, wherein the identification sequence uniquely identifies the financial authority.

18. The method of claim 13, wherein the transaction identifier is a unique identifier to reference the global purchase order.

19. The method of claim 13, wherein the transaction identifier is assigned by the financial authority.

20. The method of claim 13, wherein the producer code provides security to the transaction.
